(19) United States
(12) Patent Application Publication
(10) Pub. No.: US 2006/0017780 A1
(43) Pub. Date: Jan. 26, 2006

(54) Method of ejecting ink droplet and apparatus for ejecting ink droplet

(75) Inventor: Koichiro Hara, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 11/185,253

(22) Filed: Jul. 20, 2005

(30) Foreign Application Priority Data
Jul. 23, 2004 (JP) 2004-215365

(51) Int. Cl. B41J 2/04

(52) U.S. Cl. 347/54

(57) ABSTRACT

A method of ejecting at least one droplet of an ink through a nozzle by applying a drive pulse signal having pulses to an actuator which changes a capacity of an ink chamber, for forming a dot corresponding to one picture element with a result of ejection of the droplet, the dot to be formed being selected from among a medium-volume dot constituted by the ink of a predetermined amount, a small-volume dot constituted by the ink whose amount is smaller than the predetermined amount, and a large-volume dot constituted by the ink whose amount is larger than the predetermined amount. In the method, where the small-volume dot is formed, the droplet is ejected by a first drive pulse signal as the drive pulse signal set for the small-volume dot to eject the droplet at a predetermined ejecting speed. Further, where the medium-volume or large-volume dot is formed, the at least one droplet is ejected by a second drive pulse signal as the drive pulse signal which is set for the medium-volume or large-volume dot, which has the same voltage as the first drive pulse signal, and which has a plurality of pulses. The second drive pulse signal is determined such that a pulse width of each pulse and a time interval between each pulse are equal to respective prescribed values for making an ejecting speed of the droplet for forming the medium-volume or large-volume dot equal to the predetermined ejecting speed of the at least one droplet for forming the small-volume dot.

The present application is based on Japanese Patent Application No. 2004-215365 filed on Jul. 23, 2004, the contents of which are incorporated herein by reference.

### BACKGROUND OF THE INVENTION

1. Field of the Invention

The present invention relates in general to a method of ejecting ink droplets according to an ink-jet system and an apparatus for ejecting the ink droplet.

2. Discussion of Related Art

Conventionally, an ink-jet printing head as a printing apparatus employing the ink-jet system is arranged as follows: An ink is supplied from an ink supply source to an ink inlet of a head unit via an ink flow passage. A plate-type piezoelectric actuator mounted on the head unit selectively gives a predetermined pressure to pressure chambers respectively corresponding to a multiplicity of nozzle holes, whereby the ink is ejected from the corresponding nozzle holes.

The ink-jet system is simple in principle and permits easy realization of multiple gradation and color printing operation. As a printing apparatus employing the ink-jet system, a drop-on-demand type printing apparatus which ejects ink droplets for printing is rapidly becoming widespread because of its high ejection efficiency, a low running cost, etc.

One example of an ink-droplet ejecting apparatus which constitutes such a drop-on-demand type printing apparatus is shown in FIGS. 4A and 4B. An ink-droplet ejecting apparatus generally indicated at 200 in FIG. 4A includes an actuator plate 201 and a cover plate 202. In the actuator plate 201, there are formed a plurality of ink chambers 213 each having an elongate groove-like shape which extends in a direction of thickness of the sheet of FIGS. 4A, 4B and a plurality of dummy chambers 215 in which no ink is accommodated. Each ink chamber 213 and each dummy chamber 215 is isolated by a side wall 217 interposed therebetween. Each side wall 217 has a lower part 211 and an upper part 209 which are polarized in opposite directions P1, P2 (FIG. 4B), respectively, along the height direction of the side wall 217. Each ink chamber 213 has at its one of opposite longitudinal ends a nozzle 218 and at the other of the opposite longitudinal ends a manifold (not shown) for supplying ink. Each dummy chamber 215 is closed at its manifold-side end for inhibiting the ink from entering. On opposite side surfaces of each side wall 217, there are respectively provided electrodes 219, 221 each as a metal layer. Described more specifically, one actuator is constituted by a pair of side walls 217, 217 which sandwich the corresponding ink chamber 213 therebetween, and the electrodes 219, 221 provided on the side surfaces of each of the pair of side walls 217, 217 which sandwich that ink chamber 213. All of the electrodes 219 located in the ink chambers 213 are grounded while the electrodes 221, 221 (the dummy chamber electrodes) which are adjacent to each other with the corresponding ink chamber 213 interposed therebetween are electrically connected to each other and also connected to an output circuit for giving drive signals.

By applying a voltage from the output circuit to the two dummy chamber electrodes 221, 221 which are adjacent to each other with the corresponding ink chamber 213 interposed therebetween, the upper and the lower parts 209, 211 of each of the two adjacent side walls 217, 217 deform, by a piezoelectric shearing effect, in such directions to increase the volumetric capacity of the corresponding ink chamber 213. For instance, as shown in FIG. 4B, where an ink chamber 213b is driven, a voltage V is applied to two dummy chamber electrodes 221c, 221d which are adjacent to each other with the ink chamber 213b interposed therebetween while all of the electrodes 219 in the ink chambers are grounded. As a result, there are generated electric fields on the side walls 217c, 217d in directions indicated by arrows V, whereby the upper and the lower parts 209, 211 of the respective side walls 217c, 217d deform, by a piezoelectric shearing effect, in directions to increase the volumetric capacity of the ink chamber 213b. In this instance, the pressure in the ink chamber 213b, including the vicinity of the nozzle 218b, is reduced. By maintaining such a state for a time period T required for one-way propagation of a pressure wave along the ink chamber 213b, the ink is supplied from the manifold (not shown) for that period of time. The time period T may be hereinafter referred to as “one-way propagation time T”.

The one-way propagation time T is a time required for the pressure wave of the ink in the ink chamber 213b to propagate in a longitudinal direction thereof and is represented by an expression T=L/a, where “L” (not shown) is a length of the ink chamber 213b (as measured in the direction of thickness of the sheet of FIGS. 4A and 4B) and “a” is a speed of sound in the ink within the ink chamber 213b.

According to the theory of propagation of a pressure wave, when the time T has elapsed after the application of the voltage, the pressure in the ink chamber 213b is reversed to a positive pressure. At this timing when the pressure is reversed to the positive pressure, the voltage applied to the dummy chamber electrodes 221c, 221d is reset to 0V.

Then, the side walls 217c, 217d return to their original states shown in FIG. 4A and pressurize the ink in the ink chamber 213b. At this time, the pressure reversed to the positive pressure is combined with the pressure generated upon returning of the side walls 217c, 217d, so that a relatively high pressure is generated in the vicinity of the nozzle 218b of the ink chamber 213b, whereby the ink droplet is ejected from the nozzle 218b.

More specifically explained, if a time period between the application of the voltage and the resetting of the voltage to 0V is not equal to the above-indicated one-way propagation time T, energy efficiency for ejection of the ink droplet is lowered. In particular, when the time period is substantially even multiples of the one-way propagation time T, no ink is ejected. In general, when the time period between the application of the voltage and the resetting of the voltage to 0V is equal to the one-way propagation time T, the energy efficiency is the highest and the ejecting speed of the ink droplet is maximum. Accordingly, it is desirable that the above-indicated time period is equal to at least odd multiples of the one-way propagation time T.

Recently, it is desired that the size of a dot to be formed by at least one ink droplet, i.e., the amount of the at least one ink droplet for forming the dot is variable to produce a gray-scale image. For this end, where the dot to be formed is classified, for instance, depending upon its size or the amount of the ink which constitutes the dot, into a small-volume dot, a medium-volume dot, and a large-volume dot, it is needed that the at least one ink droplet is ejected with high stability such that the small-volume dot, the medium-volume dot, and the large-volume dot to be formed by the at least one ink droplet have respective predetermined sizes, for the purpose of improving the printing quality.

For this end, the following ink-droplet ejecting method is disclosed in U.S. Pat. Nos. 6,383,665, 6,412,896, and 6,416,149 corresponding to JP-2001-30120, for instance. In the disclosed method, where one dot corresponding to one picture element is formed with a result of ejection of the ink droplet from nozzles from one to a plural number of times by applying a drive pulse signal to an actuator which changes a capacity of ink chambers filled with the ink, the drive pulse signal is arranged to include at least one ejection pulse for ejecting the ink and at least one ejection stabilizing pulse for stabilizing vibrations of a pressure wave of the ink in the ink chambers, and pulse widths of the at least one ejection pulse and the at least one ejection stabilizing pulse and a time interval between each of the at least one ejection pulse and each of the at least one ejection stabilizing pulse are arranged to be controlled, whereby the dot to be formed by ejection of the at least one ink droplet is selected from among the small-volume dot, the medium-volume dot, and the large-volume dot.

Conventionally, where rise timing and a pulse width (width of time) of each of the at least one ejection pulse and rise timing and a pulse width (width of time) of each of the at least one ejection stabilizing pulse in each of the drive pulse signals respectively for the large-volume dot, the medium-volume dot, and the small-volume dot employed for production of a gray-scale image are obtained, the medium-volume dot was initially produced as a standard dot. Then, on the basis of the profile of the drive pulse signal used in producing the medium-volume dot as the standard dot, the rise timing and the pulse width of each of the at least one ejection pulse and the rise timing and the pulse width of each of the at least one ejection stabilizing pulse in each of the drive pulse signals respectively for the small-volume dot and the large-volume dot are determined such that the amount of the at least one ink droplet for forming the small-volume dot is substantially equal to about half that for the medium-volume dot and the amount of the at least one ink droplet for forming the large-volume dot is substantially equal to about twice that for the medium-volume dot. In this instance, each of the at least one ejection pulse of the drive pulse signal for the medium-volume dot is made to have an ejection time 1T that is equal to the one-way propagation time T described above.

Accordingly, where the drive pulse signals respectively for the small-volume dot and the large-volume dot are obtained on the basis of the drive pulse signal for the medium-volume dot having one ejection pulse, for instance, there are obtained the drive pulse signal for the small-volume dot having one ejection pulse whose pulse width is shorter than the one-way propagation time T and the drive signal for the large-volume dot having two ejection pulses each of which has a pulse width shorter than the one-way propagation time T.

However, after the printing for producing a gray-scale image was actually performed employing the three kinds of the amount of the at least one ink droplet to be ejected for forming the small-volume dot, the medium-volume dot, and the large-volume dot, it was revealed that the printing quality was not necessarily constant. Therefore, it is desired to improve the printing accuracy even where the printing for producing the gray-scale image is performed such that the size of the dot formed by the at least one ink droplet to be ejected is variable.

The cause of the poor printing quality is supposed to lie in an error in the amount of the at least one ink droplet for forming each of the large-volume dot, the medium-volume dot, and the small-volume dot and a difference in an ejecting speed among the at least one ink droplet for forming the large-volume dot, the at least one ink droplet for forming the medium-volume dot, and the at least one ink droplet for forming the small-volume dot. Accordingly, it is desirable not only to keep the amount of the at least one ink droplet for forming each of those dots constant, but also to conform the respective ejecting speeds of the ink droplets respectively for the large-volume dot, the medium-volume dot, and the small-volume dot, to one another.

### SUMMARY OF THE INVENTION

It is therefore an object of the invention to provide a method of ejecting at least one droplet of ink for forming a dot that is selected from among a medium-volume dot constituted by the ink of a predetermined amount, a small-volume dot constituted by the ink whose amount is smaller than the predetermined amount, and a large-volume dot constituted by the ink whose amount is larger than the predetermined amount, the method enabling the amounts of the ink droplets for the respective dots to keep at respective constant values and enabling ejecting speeds of the droplets respectively for the small-volume dot, the medium-volume dot, and the large-volume dot to conform to one another even where the amounts of the ink droplets for constituting the respective dots are mutually different, whereby the ink droplets for forming the respective dots can be placed or attached on or to an intended position with high accuracy. It is an optional object of the invention to provide an apparatus for ejecting the at least one droplet of ink by practicing the method.

The object indicated above may be attained according to a first aspect of the present invention, which provides a method of ejecting at least one droplet of an ink through a nozzle by applying a drive pulse signal having a plurality of pulses to an actuator which changes a capacity of an ink chamber, for forming a dot corresponding to one picture element with a result of ejection of the at least one droplet, the dot to be formed being selected from among a medium-volume dot constituted by the ink of a predetermined amount, a small-volume dot constituted by the ink whose amount is smaller than the predetermined amount, and a large-volume dot constituted by the ink whose amount is larger than the predetermined amount. In the present method, where the small-volume dot is formed, the at least one droplet is ejected by a first drive pulse signal as the drive pulse signal set for the small-volume dot to eject the at least one droplet at a predetermined ejecting speed. Further, where the medium-volume dot or the large-volume dot is formed, the at least one droplet is ejected by a second drive pulse signal as the drive pulse signal which is set for the medium-volume dot or the large-volume dot, which has the same voltage as the first drive pulse signal, and which has a plurality of pulses, the second drive pulse signal being determined such that a pulse width of each of the plurality of pulses and a time interval between each of the plurality of pulses are equal to respective prescribed values for making an ejecting speed of the at least one droplet for forming the medium-volume dot or the large-volume dot equal to the predetermined ejecting speed of the at least one droplet for forming the small-volume dot.

In the method according to the above-indicated first aspect of the invention, the respective amounts of the ink for constituting the small-volume dot, the medium-volume dot, and the large-volume dot can be kept at respective constant values and the ejecting speeds of the droplets for the respective small-volume dot, medium-volume dot, and large-volume dot are made substantially equal to one another. Therefore, the present method enables the at least one ink droplet for forming each of the dots to be placed or attached on or to an intended position with high accuracy, thereby assuring good printing quality.

The optional object indicated above may be attained according to a second aspect of the present invention, which provides an ink droplet ejecting apparatus for ejecting at least one droplet of ink, comprising: a nozzle; an ink chamber communicating with the nozzle; an actuator which changes a capacity of the ink chamber for ejecting the at least one droplet through the nozzle; and a controller which executes a control for ejecting the at least one droplet so as to form a dot corresponding to one picture element, by applying a drive pulse signal having a plurality of pulses to the actuator, the dot being selected from among a medium-volume dot constituted by the ink of a predetermined amount, a small-volume dot constituted by the ink whose amount is smaller than the predetermined amount, and a large-volume dot constituted by the ink whose amount is smaller than the predetermined amount. In the present apparatus, the controller includes: a first dot-forming control portion which executes a control for ejecting the at least one droplet so as to form the small-volume dot, by applying, to the actuator, a first drive pulse signal as the drive pulse signal set for the small-volume dot to eject the at least one droplet at a predetermined ejecting speed; and a second dot-forming control portion which executes a control for ejecting the at least one droplet for forming the medium-volume dot or the large-volume dot, by applying, to the actuator, a second drive pulse signal as the drive pulse signal which is set for the medium-volume dot or the large-volume dot, which has the same voltage as the first drive pulse signal, and which has a plurality of pulses, the second drive pulse signal being determined such that a pulse width of each of the plurality of pulses and a time interval between each of the plurality of pulses are equal to respective prescribed values for making an ejecting speed of the at least one droplet for forming the medium-volume dot or the large-volume dot equal to the predetermined ejecting speed of the at least one droplet for forming the small-volume dot.

In the apparatus constructed according to the above-indicated second aspect of the invention, the ejecting speeds of the ink droplets for the respective small-volume dot, medium-volume dot, and large-volume dot can be made substantially equal to one another, regardless of the sizes of the respective dots to be formed, i.e., regardless of the amounts of the ink droplets to be ejected for forming the respective small-volume dot, medium-volume dot, and large-volume dot. As a result, the accuracy with which the ink droplets for the respective dots are attached or placed to or on an intended location can be improved, thereby assuring good printing quality. It is noted that the apparatus according to the above-indicated second aspect of the invention may be embodied in various modes incorporating the technical features or combinations thereof which are applicable to the method of ejecting the at least one droplet of ink according to the above-described first aspect of the invention.

### BRIEF DESCRIPTION OF THE DRAWINGS

The above and other objects, features, advantages and technical and industrial significance of the present invention will be better understood by reading a following detailed description of preferred embodiments of the invention, when considered in connection with the accompanying drawings, in which:

FIG. 1A is a view showing drive pulse signals for a small-volume dot, FIG. 1B is a view showing drive pulse signals for a medium-volume dot, and FIG. 1C is a view showing drive pulse signals for a large-volume dot;

FIG. 2 is a table showing an ejecting speed of an ink droplet(s) ejected by each of the drive pulse signals of FIGS. 1A-1C;

FIG. 3 is a cross sectional view showing a part of an ink-droplet ejecting apparatus according to the present invention, the view showing a state in which ink chambers are not deformed;

FIGS. 4A and 4B are cross sectional views showing another ink-droplet ejecting apparatus, wherein FIG. 4A shows a state in which ink chambers are not deformed while FIG. 4B shows a state in which ink chambers are deformed; and

FIG. 5 is a block diagram showing functions of a controller.

### DETAILED DESCRIPTION OF THE EMBODIMENTS

Referring to the drawings, there will be explained in detail preferred embodiments of the present invention.

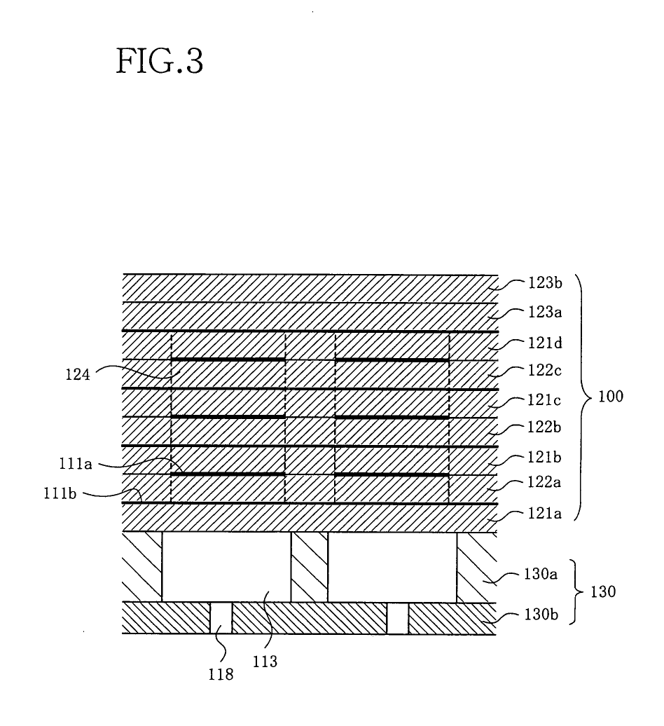

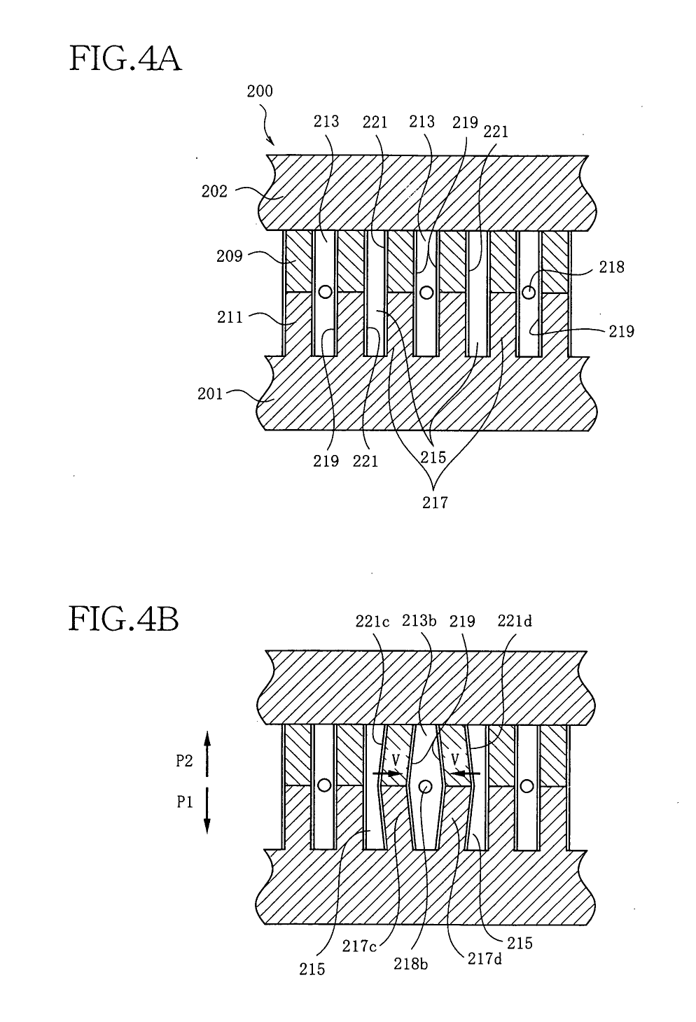

An ink-droplet ejecting apparatus according to the present invention is constituted by including an actuator 100 and a flow-passage unit 130, as shown in FIG. 3. In the present invention, the actuator 100 utilizing vibrations in a thickness direction of a piezoelectric body is used, instead of the actuator 200 (described above referring to FIGS. 4A and 4B) utilizing the piezoelectric shearing effect of the piezoelectric layers.

As shown in FIG. 3, the actuator 100 has a laminated structure comprising seven piezoelectric layers 121a, 122a, 121b, 122b, 121c, 122c, 121d each of which has an electrode layer formed on one surface thereof and two piezoelectric layers 123a, 123b which have no electrode layers. The actuator 100 constructed as described above is fixed to the flow-passage unit 130 in which are formed a plurality of ink chambers 113, such that the actuator 100 extends over the ink chambers 113. Each ink chamber 113 constitutes an ink passage. The piezoelectric layers 121a, 122a, 121b, 122b, 121c, 122c, 121d, 123a, 123b are stacked on one another in order from the lower side (the ink-chamber side) toward the upper side of FIG. 3.

Each of the lowermost piezoelectric layer 121a and the piezoelectric layers 121b, 121c, 121d has a common electrode 111b formed on one surface thereof so as to extend over the ink chambers 113. Each of the piezoelectric layers 122a, 122b, 122c has individual electrodes 111a formed one surface thereof such that a group of the individual electrodes 111a which are aligned in the stacking direction of the piezoelectric layers oppose to the corresponding ink chamber 113.

The piezoelectric layers 121a, 121b, 121c, 121d having the common electrodes 11b and the piezoelectric layers 122a, 122b, 122c having the individual electrodes 111a are stacked alternately on one another, thereby forming, on the lower portion of the actuator (as seen in FIG. 3) nearer to the ink chambers 113, active portions (pressure generating portions) 124 which deform (contract or elongate) upon application of a voltage between the individual electrodes 111a and the common electrodes 11b. The active portions 124 correspond to regions enclosed by broken line in FIG. 3. The two piezoelectric layers 123a, 123b located on the upper portion of the actuator 100 remote from the ink chambers 113 operate to restrict the deformation of the active portions 124. Accordingly, the actuator 100 deforms, as a whole, toward the ink chambers 11-3 upon application of the voltage. Each piezoelectric layer has a thickness of about 30 μm, so that the actuator 100 has a thickness of about 270 μm.

The flow-passage unit 130 to which the thus constructed actuator 100 is fixed is formed with the plurality of ink chambers 113. The flow-passage unit 130 includes a flow-passage member 130a in which are formed the ink chambers 113 and a nozzle plate 130b in which are formed a plurality of nozzles 118 through which the ink is ejected. Each ink chamber 113 has a generally elongate rectangular shape extending in a direction perpendicular to sheet plane of FIG. 3, and communicates at one end thereof with the corresponding nozzle 118 and the other end thereof with a manifold not shown. Each ink chamber 113 has a depth of 40 μm, a width of 250 μm, and a length of 1700 μm.

In the ink-droplet ejecting apparatus according to the present embodiment, portions of the piezoelectric layers corresponding to the regions enclosed with broken line in FIG. 3 elongate, owing to the piezoelectric effect, in the stacking direction of the piezoelectric layers, upon application of the voltage between the individual electrodes 111a and the common electrodes 111b, whereby the actuator 100 deforms, as a whole, into a convex shape protruding toward the ink chambers 113, so that the capacity of the ink chambers 113 is decreased. In the present embodiment, a so-called “fill-before-fire” method is employed for ejecting the ink droplet. According to the “fill-before-fire” method, in a normal state (in a non-ejection state), all of the individual electrodes 111a are kept subjected to the applied voltage, so that the capacity of the ink chambers 113 is kept in a reduced state. Immediately before the timing of ink ejection, arbitrary individual electrodes 111a are freed from the applied voltage (i.e., the applied voltage is selectively set to zero), whereby the capacity of the corresponding ink chambers 113 is increased back to the original value for drawing the ink thereinto. When the voltage is again applied, the ink droplets are ejected from the ink chambers 113.

For changing the capacity of the ink chamber 113 as described above, there is applied a drive pulse signal to the actuator 100. The drive pulse signal is constituted by: at least one ejection pulse for setting the voltage applied to the individual electrode 111a in the normal state to zero to eject at least one ink droplet; and an ejection stabilizing pulse for setting the voltage applied to the individual electrode 111a in the normal state to zero to stabilize or restrain vibrations of a pressure wave of the ink in the ink chamber 113. The pulse width of the at least one ejection pulse and the pulse width of the ejection stabilizing pulse both mean a time period during which the voltage is not applied to the individual electrode 111a. The time interval between the at least one ejection pulse and the ejection stabilizing pulse and the time interval between each of the at least one ejection pulse both mean a time period during which the voltage is applied to the individual electrode 111a.

The ejection stabilizing pulse is for damping residual pressure wave vibrations in the ink chamber 113 which are generated by the at least one ejection pulse and remain in the ink chamber 113. For instance, the ejection stabilizing pulse is for returning the capacity of the ink chamber 113 to the original value and accordingly decreasing the pressure therein at the time when the pressure in the ink chamber 113 increases and for reducing the capacity of the ink chamber 113 and accordingly increasing the pressure therein at the time when the pressure in the ink chambers 113 decreases. Owing to this action of the ejecting stabilizing pulse, the pressure wave vibrations can be restricted.

In the present embodiment, the ejection stabilizing pulse follows the at least one ejection pulse, so that the amount of the at least one ink droplet to be ejected can be kept constant.

The drive pulse signal makes the actuator 100 operate as described above. Accordingly, for changing the amount of the at least one ink droplet to be ejected, the voltage to be applied, the pulse width of each of the at least one ejection pulse, the rise timing of each of the at least one ejection pulse and/or the rise timing of the ejection stabilizing pulse is changed.

It is possible to decrease or increase the amount of the at least one ink droplet to be ejected and to keep the increased or decreased amount as described above. However, where the ink droplets of the respective amounts for forming the small-volume dot, the medium-volume dot, and the large-volume dot are ejected, the printing state is unstable unless the ejecting speeds of the ink droplets for the respective small-volume dot, the medium-volume dot, and large-volume dot are equal to one another.

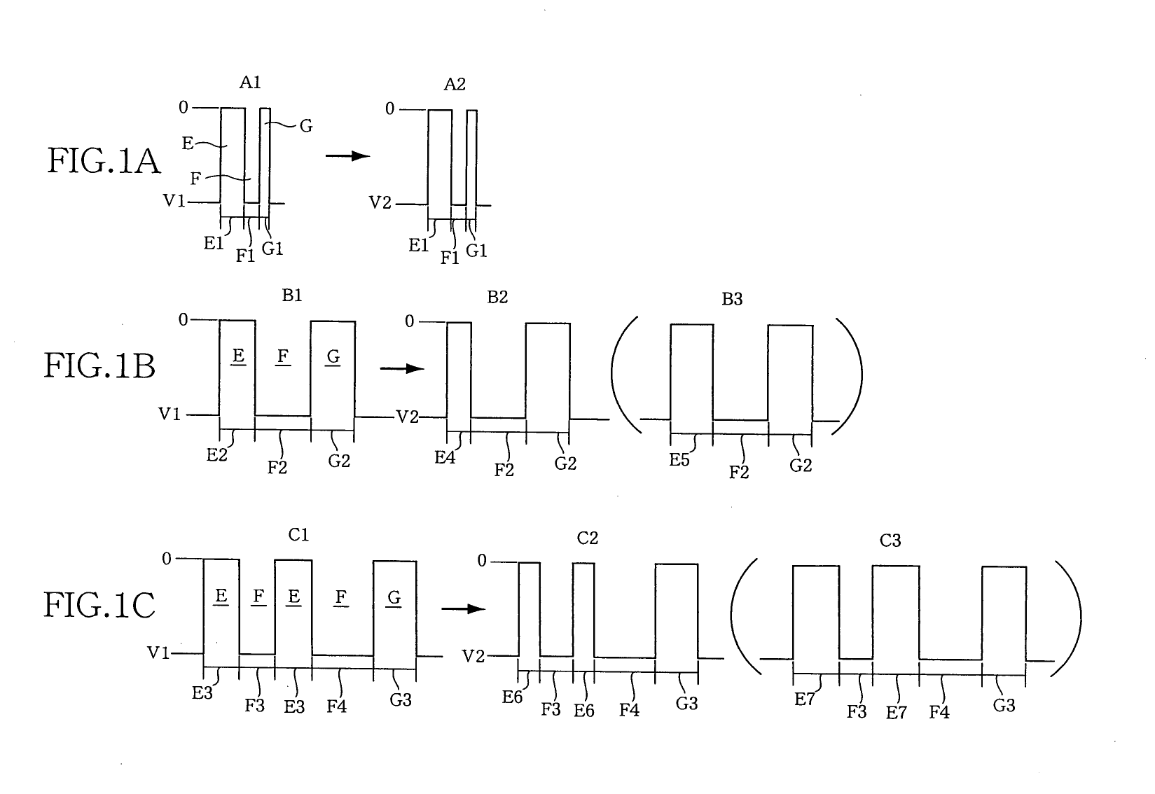

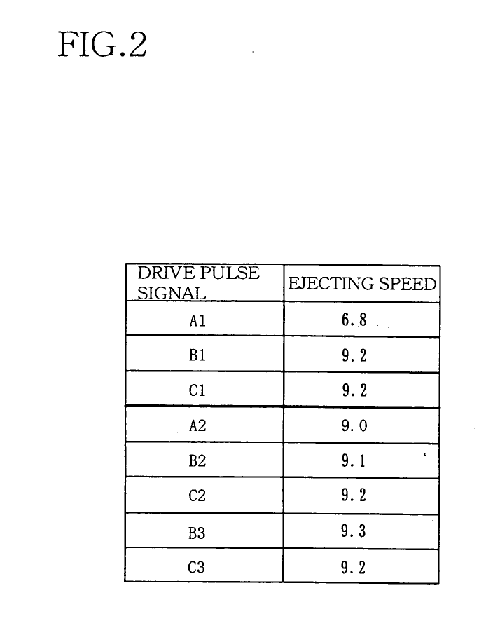

Hereinafter, there will be explained drive pulse signals respectively for a small-volume dot, a medium-volume dot, and a large-volume dot according to the present embodiment, referring to FIGS. 1A-1C and FIG. 2.

FIGS. 1A-1C show drive pulse signals having respective waveforms. Described in detail, in FIG. 1A, a drive pulse signal A1 is a conventional drive pulse signal for the small-volume dot while a drive pulse signal A2 is a novel drive pulse signal for the small-volume dot according to the present invention. In FIG. 1B, a drive pulse signal B1 is a conventional drive pulse signal for the medium-volume dot while drive pulse signals B2, B3 are novel drive pulse signals for the medium-volume dot according to the present invention. In FIG. 1C, a drive pulse signal C1 is a conventional drive pulse signal for the large-volume dot while drive pulse signals C1, C2 are novel drive pulse signals for the large-volume dot according to the present invention. As clearly shown in FIGS. 1A-1C, the drive pulse signals A1, A2 for the small-volume dot respectively have one ejection pulse (E) and one ejection stabilizing pulse (G). Similarly, the drive pulse signals B1, B2, B3 for the medium-volume dot respectively have one ejection pulse (E) and one ejection stabilizing pulse (G). The drive pulse signals C1, C2, C3 for the large-volume dot respectively have two ejection pulses (E), i.e., a first ejection pulse and a second ejection pulse and one ejection stabilizing pulse (G). One ink droplet is ejected so as to correspond to one ejection pulse.

The conventional drive pulse signal A1 for the small-volume dot and the conventional drive pulse signal C1 for the large-volume dot are determined on the basis of the conventional drive pulse signal B1 for the medium-volume dot.

For this end, a pulse width E2 of the ejection pulse E of the conventional drive pulse signal B1 for the medium-volume dot is made equal to the above-indicated one-way propagation time T and the applied voltage (the drive voltage) is set at V1. In this instance, in the conventional drive pulse signal A1 for the small-volume dot that is constituted by the ink whose amount is substantially about half that for the medium-volume dot, a pulse width E1 of the ejection pulse E is equal to 0.75T which is shorter than the one-way propagation time T. Further, in the conventional drive pulse signal C1 for the large-volume dot that is constituted by the ink whose amount is substantially about twice that for the medium-volume dot, respective pulse widths E3 of the first ejection pulse and the second ejection pulse are both equal to 1.2T and the applied voltage is set at V1 (e.g., 23 volt) which is the same as that of the conventional drive pulse signal B1 for the medium-volume dot.

In the conventional drive pulse signal A1 for the small-volume dot, the pulse width E1 of the ejection pulse E, a time interval F1 between the ejection pulse E and the ejection stabilizing pulse G, and a pulse width of the ejection stabilizing pulse G are 0.75T, 0.6T, and 0.35T, respectively.

In the conventional drive pulse signal B1 for the medium-volume dot, the pulse width E2 of the ejection pulse E, a time interval F2 between the ejection pulse E and the ejection stabilizing pulse G, and a pulse width G2 of the ejection stabilizing pulse G are 1T, 1.725T, and 1.525T, respectively.

In the conventional drive pulse signal C1 for the large-volume dot, the pulse width E3 of the first ejection pulse, a time interval F3 between the first ejection pulse and the second ejection pulse, the pulse width E3 of the second ejection pulse, and a time interval F4 between the second ejection pulse and the ejection stabilizing pulse, and a pulse width G3 of the ejection stabilizing pulse are 1.2T, 1T, 1.2T, 1.925T, and 1.4T, respectively.

In the conventional arrangement, the amount of one ink droplet for the small-volume dot to be ejected so as to correspond to one ejection pulse (i.e., the amount of the ink which constitutes the small-volume dot) is 5 pl, the amount of one ink droplet for the medium-volume dot to be ejected so as to correspond to one ejection pulse (i.e., the amount of the ink which constitutes the medium-volume dot) is 10 pl, and the amount of the two ink droplets for the large-volume dot to be ejected so as to correspond to the respective two ejection pulses (i.e., the amount of the ink which constitutes the large-volume dot) is 20 pl.

The ejecting speeds of the droplets for the respective small-volume dot, medium-volume dot, and large-volume dot which are ejected by the conventional drive pulse signals A1, B1, C1, respectively, were measured at the applied voltage of 23 volt and at a temperature of 25° C. The results are indicated in the table of FIG. 2. As shown in the table, the ejecting speeds of the droplets for the respective small-volume dot, medium-volume dot, and large-volume dot that were ejected respectively by the conventional drive pulse signals A1, B1, C1 were 6.8 m/s, 9.2 m/s, and 9.2 m/s, respectively. In other words, the ejecting speeds of the droplets for the medium-volume dot and the large-volume dot are substantially equal to 9 m/s which is an intended value whereas the ejecting speed of the droplet for the small-volume dot is lower than 9 m/s.

The ejecting speeds were measured by stroboscope photographing based on each ink droplet at a location distant from the outlet of the nozzle by 0.5 mm. The amounts of the ink were obtained by measuring the volume of the ink remaining in an ink container after a plural number of times of ink ejection and calculating, on the basis of the measured volume, the amounts of the ink for forming one dot, i.e., one small-volume dot, one medium-volume dot, and one large-volume dot.

In the conventional drive pulse signal A1 for the small-volume dot, the ejection stabilizing pulse G follows immediately after the ejection pulse E1 having the pulse width E1 of 0.75T, in other words, after elapse of 0.6T from termination of the ejection pulse E1. Accordingly, the ejecting speed of the droplet for the small-volume dot is reduced by influence of drawing action by which the ink droplet under ejection is fed back into the nozzle.

Where the droplet of a very small amount of the ink (i.e., 5 pl) is ejected, for forming the small-volume dot, on the basis of the ejecting conditions of the droplet for the medium-volume dot according to the conventional ink-droplet ejecting method, the ejecting speed is inevitably decreased. To meet a demand for high-quality printing which requires a further fine droplet, it is considered that the pulse width E1 of the ejection pulse E is made smaller. In this case, however, the ejecting speed of the ink droplet for the small-volume dot deviates from those of the ink droplets for the respective medium-volume dot and large-volume dot, to a much larger extent. In addition, where the pulse width E1 of the ejection pulse E of the conventional drive pulse signal A1 for the small-volume dot is made smaller, the ink ejecting characteristics may become unstable. Therefore, there is practically a limit in reduction in the pulse width E1 of the ejection pulse E. For compensating for the reduction in the ejecting speed, it may be considered that the drive voltage is increased only when the droplet for the small-volume dot is ejected. It is, however, needed to prepare an additional power source to eject the droplet for the small-volume dot, inevitably resulting in increase in the size of the apparatus and the cost for manufacture of the apparatus.

The ejecting speed can be increased by changing the waveform of the drive pulse signal or by increasing the drive voltage of the drive pulse signal.

It is, however, easy to change the drive voltage of the drive pulse signal rather than to change the waveform of the drive pulse signal set in advance. Further, the provision of the power source in a minimized number is advantageous in terms of not only simplification of the apparatus but also reduction in the cost. In the light of the above, a common power source is used irrespective of the amount of the ink droplet to be ejected, i.e., irrespective of the size of the dot to be formed, and there is obtained a drive voltage that makes the ejecting speed of the droplet for the small-volume dot equal to the intended ejecting speed of about 9 m/s that is substantially equal to the ejecting speeds of the droplets for the respective medium-volume dot and large-volume dot.

Without changing the waveform of the conventional drive pulse signal A1 for the small-volume dot, there was obtained the drive voltage of the drive pulse signal for the small-volume dot which makes the ejecting speed of the droplet for the small-volume dot equal to the above-described ejecting speed of the droplets for the respective medium-volume dot and large-volume dot. The obtained drive voltage is V2 (e.g., 25 volt), in contrast with the conventional drive voltage V1 (e.g., 23 volt).

Next, at the drive voltage V2, two drive pulse signals B2, B3 (FIG. 1B) for the medium-volume dot that is constituted by the ink droplet whose amount is 10 pl and two drive pulse signals C2, C3 (FIG. 1C) for the large-volume dot that is constituted by the ink droplets whose amount in total is 20 pl were obtained. The drive pulse signals B2, B3 for the medium-volume dot and the drive pulse signals C2, C3 for the large-volume dot which assure the respective intended amounts of the respective ink droplets and the intended ejecting speed were obtained by merely changing the pulse widths E2, E3 of the ejection pulse or pulses of the conventional drive pulse signals B1, C1. Further, in the obtained drive pulse signals B2, B3 for the medium-volume dot, the time interval (F2) between the ejection pulse and the ejection stabilizing pulse and the pulse width (G2) of the ejection stabilizing pulse are not changed, namely, the same as those of the conventional drive pulse signal B1. Similarly, in the obtained drive pulse signals C2, C3 for the large-volume dot, the time interval (F3) between the first and second ejection pulses, the time interval (F4) between the second ejection pulse and the ejection stabilizing pulse, and the pulse width (G3) of the ejection stabilizing pulse are not changed, namely, the same as those of the conventional drive pulse signal C1.

Thus, the drive pulse signals B2, B3 for the medium-volume dot and the drive pulse signals C2, C3 for the large-volume dot can be obtained simply by changing the conventional drive voltage V1 (e.g., 23 volt) to the drive voltage V2 (e.g., 25 volt) and changing the pulse width of each ejection pulse so as to be shorter or longer than the one-way propagation time T, for instance.

In the drive pulse signal B2 for the medium-volume dot according to the present embodiment, the pulse width E4 of the ejection pulse, the time interval F2 between the ejection pulse and the ejection stabilizing pulse, the pulse width G2 of the ejection stabilizing pulse are 0.74T, 1.725T, and 1.525T, respectively. Further, in the drive pulse B3, the pulse width E5 of the ejection pulse, the time interval F2 between the ejection pulse and the ejection stabilizing pulse, and the pulse width G2 of the ejection stabilizing pulse are 1.3 T, 1.725T, and 1.525T, respectively.

Where the ink droplet for the small-volume dot is ejected by the drive pulse signal A2 and the ink droplet for the medium-volume dot is ejected by the drive pulse signal B2 or the drive pulse signal B3, it is possible to eject, for forming the medium-volume dot, the ink droplet whose amount is substantially about twice that of the ink droplet for the small-volume dot, by using the two drive pulse signals B2, B3 one B2 of which employs the ejection pulse whose pulse width E4 is shorter than the one-way propagation time T and the other B3 of which employs the ejection pulse whose pulse width E5 is longer than the one-way propagation time T.

In the drive pulse signal C2 for the large-volume dot according to the present embodiment, the pulse width E6 of the first ejection pulse, the time interval F3 between the first and second ejection pulses, the pulse width E6 of the second ejection pulse, the time interval F4 between the second ejection pulse and the ejection stabilizing pulse, and the pulse width G3 of the ejection stabilizing pulse are 0.72T, 1T, 0.72T, 1.925T, and 1.4T, respectively. Further, in the drive pulse signal C3, the pulse width E7 of the first ejection pulse, the time interval F3 between the first and second ejection pulses, the pulse width E7 of the second ejection pulse, the time interval F4 between the second ejection pulse and the ejection stabilizing pulse, and the pulse width G3 of the ejection stabilizing pulse are 1.6T, 1T, 1.6T, 1.925T, and 1.4T, respectively.

Where the ink droplet for the small-volume dot is ejected by the drive pulse signal A2 and the two ink droplets for the large-volume dot are ejected by the drive pulse signal C2 or the drive pulse signal C3, it is possible to eject, for forming the large-volume dot, the two ink droplets whose amount in total is substantially about twice the amount of the ink droplet for the medium-volume dot, by using the two drive pulse signals C2, C3 one C2 of which employs the two ejection pulses whose pulse widths E6 are shorter than the one-way propagation time T and the other C3 of which employs the two ejection pulses whose pulse widths E7 are longer than the one-way propagation time T.

The ejecting speeds of the ink droplets for the respective small-volume dot, medium-volume dot, and large-volume dot in the present embodiment were measured according to the above-described method. The results of the measurement are indicated in the table of FIG. 2. As shown in the table of FIG. 2, the ejecting speed of the droplet ejected by the drive pulse signal A2 for the small-volume dot the ejecting speed of the droplet ejected by the drive pulse signal B2 for the medium-volume droplet, and the ejecting speed of the droplets ejected by the drive pulse signal C2 for the large-volume dot are 9.0 m/s, 9.1 m/s, and 9.2 m/s, respectively. Further, the ejecting speed of the droplet ejected by the drive pulse signal B3 for the medium-volume dot and the ejecting speed of the droplets ejected by the drive pulse signal C3 for the large-volume dot are 9.3 m/s and 9.2 m/s, respectively. Namely, any of the ink droplets for the respective small-volume dot, medium-volume dot, large-volume dot can be ejected at substantially the same speed of 9 m/s. In other words, the ejecting speeds of the droplets for the respective small-volume dot, medium-volume dot, and large-volume dot can be made substantially equal to one another.

In the present ink-droplet ejecting method, for forming a dot corresponding to one picture element with a result of ejection of the ink droplet from one to a plural number of times, the dot to be formed is arranged to be selected from among the medium-volume dot constituted by the ink of the predetermined amount, the small-volume dot constituted by the ink whose amount is substantially about half the predetermined amount, and the large-volume dot constituted by the ink whose amount is substantially about twice the predetermined amount, and each of the drive pulse signals for the respective small-volume dot, medium-volume dot, and large-volume dot is arranged to include at least one ejection pulse E for ejecting the ink droplet and the at least one ejection stabilizing pulse G for stabilizing the vibrations of the pressure wave of the ink in the ink chamber. Further, as to the at least one ink droplet for the small-volume dot which tends to suffer from unstable ejecting characteristics, the drive voltage V2 of the drive pulse signal by which the at least one ink droplet for the small-volume dot is ejected at a predetermined speed is set in advance, and the droplets for the respective medium-volume dot and large-volume dot are ejected by the respective drive pulse signals whose drive voltages are the same as the drive voltage V2 of the drive pulse signal for the small-volume dot. Moreover, in each of the drive pulse signals for the respective medium-volume dot and large-volume dot, the pulse width of the at least one ejection pulse E, the pulse width of the at least one ejection stabilizing pulse G, the time interval between the at least one ejection pulse and the at least one ejection stabilizing pulse, and the time interval between each of the at least one ejection pulse are set at the respective suitable values. Therefore, even where the amounts of the ink droplets to be ejected for forming the respective small-volume dot, medium-volume dot, and large-volume dot are made different from one another as described above, the respective amounts of the ink droplets can be maintained and the ejecting speeds of the droplets for the respective small-volume dot, medium-volume dot, and large-volume dot can coincide with the intended ejecting speed suitable for printing according to the ink-jet method. Hence, the accuracy with which the droplets for the respective dots are attached or placed to or on an intended location can be improved, thereby assuring good printing quality.

Moreover, where the one-way propagation time of the pressure wave of the ink in the ink chamber is represented by T, the pulse width of the at least one ejection pulse of each of the drive pulse signals for the respective medium-volume dot and large-volume dot can be made shorter or longer than the one-way propagation time T after setting of the drive pulse signal for the small-volume dot. Therefore, in both of a case in which the medium-volume dot is formed and a case in which the large-volume dot is formed, it is possible to set a program for ink-droplet ejection by employing at least one of the drive pulse signal whose at least one ejection pulse has the pulse width shorter than the one-way propagation time T and the drive pulse signal whose at least one ejection pulse has the pulse width longer than the one-way propagation time T, thereby permitting an extensive range of programming for ink-droplet ejection.

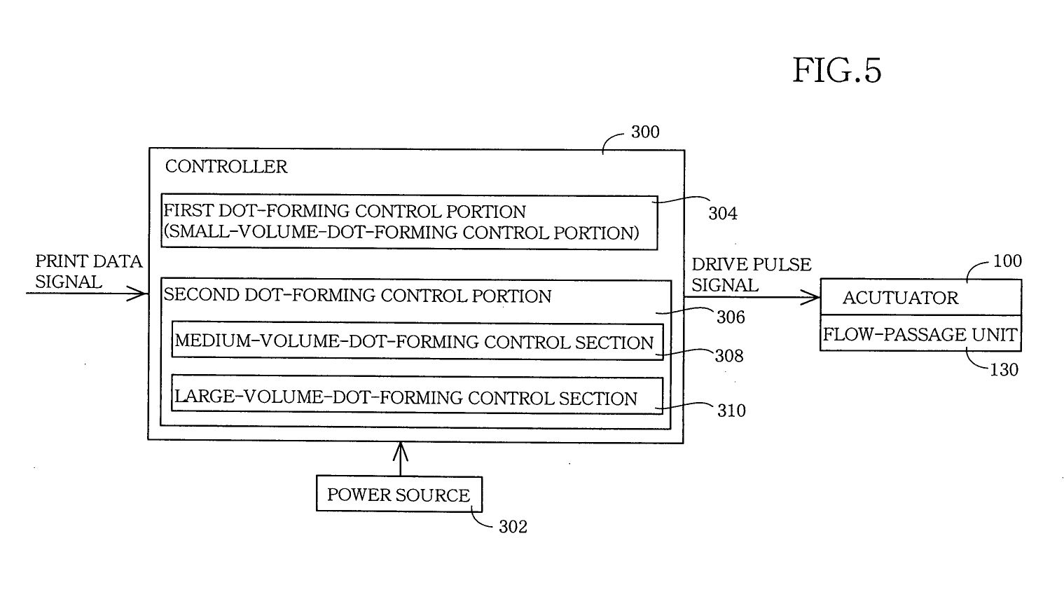

The ink-droplet ejecting apparatus of the present invention includes a controller 300 as shown in FIG. 5. In a hardware arrangement, the controller 300 is constituted by including a computer having a CPU, a ROM, a RAM, etc., and a drive circuit. As the controller 300, there may be employed those having a known hardware structure. A detailed explanation of the hardware structure is dispensed with. The controller 300 utilizes electric power supplied from a power source 302 connected thereto and generates, on the basis of a print data signal inputted thereto, a drive pulse signal to be outputted to the actuator 100.

In FIG. 5, the controller 300 is shown by a block diagram. The controller 300 includes: a first dot-forming control portion 304 as a functional portion for outputting, to the actuator 100, a drive pulse signal for forming the small-volume dot; and a second dot-forming control portion 306 as a functional portion for outputting, to the actuator 100, a drive pulse signal for forming the medium-volume dot or the large-volume dot. Further, the second dot-forming control portion 306 includes: a medium-volume-dot-forming control section 308 for outputting, to the actuator 100, a signal for forming the medium-volume dot; and a large-volume-dot-forming control section 310 for outputting, to the actuator 100, a signal for forming the large-volume dot. The first dot-forming control portion 304, the medium-dot-forming control section, 308, and the large-volume-dot-forming control section 310 selectively operate depending on the dot to be formed, and respectively generate the drive pulse signals explained above for outputting the drive pulse signals to the actuator 100. Since the drive pulse signals have been explained in detail, the explanation is not given.

In the illustrated embodiment, “fill-before-fire” method is employed for ejecting the ink droplet. The principle of the invention is equally applicable to a case where a so-called “fire-before-fill” method is employed wherein the voltage is not applied to the individual electrodes in the normal state (in the non-ejection state), and, when the voltage is selectively applied to arbitrary individual electrodes, the ink droplets are ejected from the corresponding ink chambers.

It is to be understood that the invention is not limited to the details of the illustrated embodiments, but may be embodied with various changes and modifications, which may occur to those skilled in the art, without departing from the spirit and scope of the invention defined in the attached claims.

What is claimed is:

1. A method of ejecting at least one droplet of an ink through a nozzle by applying a drive pulse signal having a plurality of pulses to an actuator which changes a capacity of an ink chamber, for forming a dot corresponding to one picture element with a result of ejection of the at least one droplet, the dot to be formed being selected from among a medium-volume dot constituted by the ink of a predetermined amount, a small-volume dot constituted by the ink whose amount is smaller than the predetermined amount, and a large-volume dot constituted by the ink whose amount is larger than the predetermined amount,
wherein, where the small-volume dot is formed, the at least one droplet is ejected by a first drive pulse signal as the drive pulse signal set for the small-volume dot to eject the at least one droplet at a predetermined ejecting speed,
and wherein, where the medium-volume dot or the large-volume dot is formed, the at least one droplet is ejected by a second drive pulse signal as the drive pulse signal which is set for the medium-volume dot or the large-volume dot, which has the same voltage as the first drive pulse signal, and which has a plurality of pulses, the second drive pulse signal being determined such that a pulse width of each of the plurality of pulses and a time interval between each of the plurality of pulses are equal to respective prescribed values for making an ejecting speed of the at least one droplet for forming the medium-volume dot or the large-volume dot equal to the predetermined ejecting speed of the at least one droplet for forming the small-volume dot.

2. The method according to claim 1,
wherein, where the medium-volume dot is formed, the at least one droplet is ejected by a signal which is set for the medium-volume dot and which is one kind of the second drive pulse signal,
and wherein, where the large-volume dot is formed, the at least one droplet is ejected by a signal which is set for the large-volume dot and which is another kind of the second drive pulse signal different from the signal set for the medium-volume dot.

3. The method according to claim 1, wherein the amount of the ink for the small-volume dot is substantially half the predetermined amount for the medium-volume dot and the amount of the ink for the large-volume dot is substantially twice the predetermined amount for the medium-volume dot.

4. The method according to claim 1, wherein the plurality of pulses of the drive signal to be applied to the actuator includes at least one ejection pulse for ejecting the at least one droplet of the ink and at least one ejection stabilizing pulse for stabilizing vibrations of a pressure wave in the ink chamber.

5. The method according to claim 1,
wherein the plurality of pulses of the second drive pulse signal includes at least one ejection pulse for ejecting the at least one droplet of the ink,
and wherein, where a time period of one-way propagation of a pressure wave in the ink chamber is represented by T, a pulse width of the at least one ejection pulse is shorter than T.

6. The method according to claim 1,
wherein the plurality of pulses of the second drive pulse signal includes at least one ejection pulse for ejecting the at least one droplet of the ink,
and wherein, where a time period of one-way propagation of a pressure wave in the ink chamber is represented by T, a pulse width of the at least one ejection pulse is longer than T.

7. The method according to claim 4,
wherein the amount of the ink for the small-volume dot is substantially half the predetermined amount for the medium-volume dot,
wherein the second drive pulse is for ejecting the medium-volume dot,
wherein the first drive pulse signal and the second drive pulse signal respectively include one ejection pulse and one ejection stabilizing pulse,
and wherein, where a pulse width of the ejection pulse, a time interval between the ejection pulse and the ejection stabilizing pulse, and a pulse width of the ejection stabilizing pulse, of the first drive pulse signal are 0.75T, 0.6T, and 0.35T, respectively, in which T represents a time period of one-way propagation of a pressure wave in the ink chamber, a pulse width of the ejection pulse, a time interval between the ejection pulse and the ejection stabilizing pulse, and a pulse width of the ejection stabilizing pulse, of the second drive pulse signal are 0.74T, 1.725T, and 1.525T, respectively.

8. The method according to claim 4,
wherein the amount of the ink for the small-volume dot is substantially half the predetermined amount for the medium-volume dot,
wherein the second drive pulse signal is for ejecting the medium-volume dot,
wherein the first drive pulse signal and the second drive pulse signal respectively include one ejection pulse and one ejection stabilizing pulse,
and wherein, where a pulse width of the ejection pulse, a time interval between the ejection pulse and the ejection stabilizing pulse, and a pulse width of the ejection stabilizing pulse, of the first drive pulse signal are 0.75T, 0.6T, and 0.35T, respectively, in which T represents a time period of one-way propagation of a pressure wave in the ink chamber, a pulse width of the ejection pulse, a time interval between the ejection pulse and the ejection stabilizing pulse, and a pulse width of the ejection stabilizing pulse, of the second drive pulse signal are 1.3T, 1.725T, and 1.525T, respectively.

9. The method according to claim 4,
wherein the amount of the ink for the small-volume dot is substantially half the predetermined amount for the medium-volume dot while the amount of the ink for the large-volume dot is substantially twice the predetermined amount for the medium-volume dot,
wherein the second pulse signal is for ejecting the large-volume dot,
wherein the first drive pulse signal includes one ejection pulse and one ejection stabilizing pulse while the second drive pulse signal includes a first ejection pulse, a second ejection pulse, and one ejection stabilizing pulse,
and wherein, where a pulse width of the ejection pulse, a time interval between the ejection pulse and the ejection stabilizing pulse, and a pulse width of the ejection stabilizing pulse, of the first drive pulse signal are 0.75T, 0.6T, and 0.35T, respectively, in which T represents a time period of one-way propagation of a pressure wave in the ink chamber, a pulse width of the first ejection pulse, a time interval between the first ejection pulse and the second ejection pulse, a pulse width of the second ejection pulse, a time interval between the second ejection pulse and the ejection stabilizing pulse, and a pulse width of the ejection stabilizing pulse, of the second drive pulse signal are 0.72T, 1T, 0.72T, 1.925T, and 1.4T, respectively.

10. The method according to claim 4,
wherein the amount of the ink for the small-volume dot is substantially half the predetermined amount for the medium-volume dot while the amount of the ink for the large-volume dot is substantially twice the predetermined amount for the medium-volume dot,
wherein the second drive pulse signal is for ejecting the large-volume dot,
wherein the first drive pulse signal includes one ejection signal and one ejection stabilizing signal while the second drive pulse signal includes a first ejection pulse, a second ejection pulse, and one ejection stabilizing pulse,
and wherein, where a pulse width of the ejection pulse, a time interval between the ejection pulse and the ejection stabilizing pulse, and a pulse width of the ejection stabilizing pulse, of the first drive pulse signal are 0.75T, 0.6T, and 0.35T, respectively, in which T represents a time period of one-way propagation of a pressure wave in the ink chamber, a pulse width of the first ejection pulse, a time interval between the first ejection pulse and the second ejection pulse, a pulse width of the second ejection pulse, a time interval between the second ejection pulse and the ejection stabilizing pulse, and a pulse width of the ejection stabilizing pulse, of the second drive pulse signal are 1.6T, 1T, 1.6T, 1.925T, and 1.4T, respectively.

11. An ink droplet ejecting apparatus for ejecting at least one droplet of ink, comprising:
a nozzle;
an ink chamber communicating with the nozzle;
an actuator which changes a capacity of the ink chamber for ejecting the at least one droplet through the nozzle; and
a controller which executes a control for ejecting the at least one droplet so as to form a dot corresponding to one picture element, by applying a drive pulse signal having a plurality of pulses to the actuator, the dot being selected from among a medium-volume dot constituted by the ink of a predetermined amount, a small-volume dot constituted by the ink whose amount is smaller than the predetermined amount, and a large-volume dot constituted by the ink whose amount is smaller than the predetermined amount,
wherein the controller includes: a first dot-forming control portion which executes a control for ejecting the at least one droplet so as to form the small-volume dot, by applying, to the actuator, a first drive pulse signal as the drive pulse signal set for the small-volume dot to eject the at least one droplet at a predetermined ejecting speed; and a second dot-forming control portion which executes a control for ejecting the at least one droplet for forming the medium-volume dot or the large-volume dot, by applying, to the actuator, a second drive pulse signal as the drive pulse signal which is set for the medium-volume dot or the large-volume dot, which has the same voltage as the first drive pulse signal, and which has a plurality of pulses, the second drive pulse signal being determined such that a pulse width of each of the plurality of pulses and a time interval between each of the plurality of pulses are equal to respective prescribed values for making an ejecting speed of the at least one droplet for forming the medium-volume dot or the large-volume dot equal to the predetermined ejecting speed of the at least one droplet for forming the small-volume dot.

12. The apparatus according to claim 11, wherein the second dot-forming control portion includes: a medium-volume-dot-forming control section which executes a control for ejecting the at least one droplet so as to form the medium-volume dot, by applying, to the actuator, a signal which is set for the medium-volume dot and which is one kind of the second drive pulse signal; and a large-volume-dot-forming control section which executes a control for ejecting the at least one droplet so as to form the large-volume dot, by applying a signal which is set for the large-volume dot and which is another kind of the second drive pulse signal different from the signal set for the medium-volume dot.
